(19) United States
(12) Patent Application Publication
(10) Pub. No.: US 2005/0034118 A1
(43) Pub. Date: Feb. 10, 2005

(54) Systems and methods for transferring information to a computer memory

(75) Inventors: Jayathysan K. Raman, DeBary, FL (US); Robert Segal, Orlando, FL (US); Adnan A. Jumani, Kissimmee, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Business Services Inc.

(21) Appl. No.: 10/889,825

(22) Filed: Jul. 13, 2004

Related U.S. Application Data
(60) Provisional application No. 60/487,504, filed on Jul. 15, 2003.

(51) Int. Cl. G06F 9/445

(52) U.S. Cl. 717/174

(57) ABSTRACT

Systems and methods for creating a software image for subsequent installation on a target computer system. These systems and methods may include hardware and steps for creating an image of software on a source computer; transferring the image to a recipient computer; installing the imaged software the recipient computer; updating the hardware abstraction layer on the recipient computer to a required version; imaging the software on the recipient computer with the required hardware abstraction layer; and installing the image of the recipient computer on a target computer system.

### PRIORITY

This application claims priority from U.S. provisional application 60/487,504 filed on Jul. 15, 2003.

### BACKGROUND OF THE INVENTION

The present invention relates to systems and methods for transferring information to a computer memory, and more particularly to systems and methods for transferring imaged information to a computer hard drive.

Operating systems are at the center of computer systems and provide an environment in which software applications and computer hardware interoperate. The operating system oversees system operations including the managing, scheduling, and allocating of computer resources and provides various interfaces and modules used by individual application programs to accomplish particular tasks.

In the past, installation of software such as an application program or an operating system was accomplished by discovering information about the hardware and existing software on the computer system, copying and decompressing the appropriate source operating system files, installing those files through such methods as library registration, and then configuring those installed files based on user input. Many of the above-described actions, particularly in the file installation phase, are the same regardless of the system on which they are installed. In such prior art systems, discovering system information, copying and decompressing files, installing and registering files, and configuring user preferences all require a significant amount of time.

Recently, more efficient methods of installing or copying computer software have emerged. One such technology is known as disk imaging technology. With this technique, copies of preinstalled files are copied or “imaged” from a source computer and then transferred to the memory of a target computer over a communications link rather than performing the time consuming installation process described above. Many of the traditional installation tasks are performed only once during the creation of the master software image and prior to installation the target computer. This relieves a computer operator of the need to re-perform the same cumbersome installation tasks over and over for each system that requires substantially the same software.

One benefit of this scheme is that it allows information technologists to control the software configuration of multiple machines such as notebook computers and network workstations by ensuring the same (or similar) software is installed to promote overall compatibility or version uniformity. Another benefit is the reduction of time required to install an imaged software package compared to prior installation methods as well as a reduced likelihood of human error.

More recently, sophisticated software packages such as modern operating systems (e.g., Windows XP) and other application programs using hardware abstraction layers (HALs) have been introduced. HALs are desirable because they provide an “abstract” interface between a computer's hardware and software, which effectively decouples the software from hardware dependent details in a particular system such as I/O interfaces, interrupt controllers, and multiprocessor communication mechanisms. With this implementation, applications and device drivers in the system software do not communicate with hardware directly but rather make calls to HAL routines to determine hardware specific information. This allows, among other things, a particular software package to run on systems with different hardware configurations because the software communicates with the HAL in substantially the same manner on each different system with system specifics provided by the HAL layer.

However, because different HALs exist for different computer systems, copying a HAL-based program from one computer to another requires creating a different disk image for each HAL-type to ensure that an image with a matching HAL-type is installed on a target computer. This is undesirable for several reasons. One reason is because it requires multiple disk images to be prepared for each HAL-type, even if the underlying software is the same. Another reason is that a computer user needs to keep track of all the HAL versions on various computers and install the proper disk image on a computer with a corresponding HAL. This undesirably complicates the software installation and maintenance process.

Therefore, in view of the foregoing, it would be desirable to provide systems and methods that overcome the shortcomings of the prior art.

It therefore would be desirable to provide systems and methods that allow disk images of one HAL type to be installed on systems with the same HAL type.

It therefore would be further desirable to provide systems and methods that allow a disk image of one HAL type to be installed on all other systems with a different HAL type.

### SUMMARY OF THE INVENTION

It is therefore an object of the invention to provide systems and methods that allow disk images of one HAL type to be installed on systems with the same HAL type.

It is therefore a further object of the invention to provide systems and methods that allow a disk image of one HAL type to be installed on other systems with a different HAL type.

These and other objects of the invention are accomplished in accordance with the principles of the present invention by providing systems and methods for creating a software image for subsequent installation on a target computer system. These systems and methods may include hardware and steps for creating an image of a software application on a source computer. The software application image created may be transferred to a recipient computer. In some embodiments, the source computer and the recipient computer may be the same computer. The transferred software application image may then be installed on the recipient computer. If necessary, the hardware abstraction layer on the recipient computer may be updated to a required version. The installed software on the recipient computer along with the required hardware abstraction layer may be imaged and subsequently installed on a target computer system.

### BRIEF DESCRIPTION OF THE DRAWINGS

The above and other objects and advantages of the present invention will be apparent upon consideration of the following detailed description, taken in conjunction with the accompanying drawings in which like reference characters refer to like parts throughout and in which:

FIG. 1 is a generalized block diagram of a system for installing software to a target computer system from a source computer system in accordance with one embodiment of the present invention.

FIG. 2 is a flow chart illustrating some of the steps involved in installing software to a target computer system from a source computer system in accordance with one embodiment of the present invention.

FIG. 3 is a flow chart illustrating some additional steps for changing the HAL version of a recipient system in accordance with one embodiment of the present invention.

### DETAILED DESCRIPTION OF THE INVENTION

Although the present invention is described below in some instances in connection with the imaging and installation of an operating system, it will be understood that the principles and novel concepts described herein may be used with application programs or other types of software that communicate through a hardware abstraction layer (HAL).

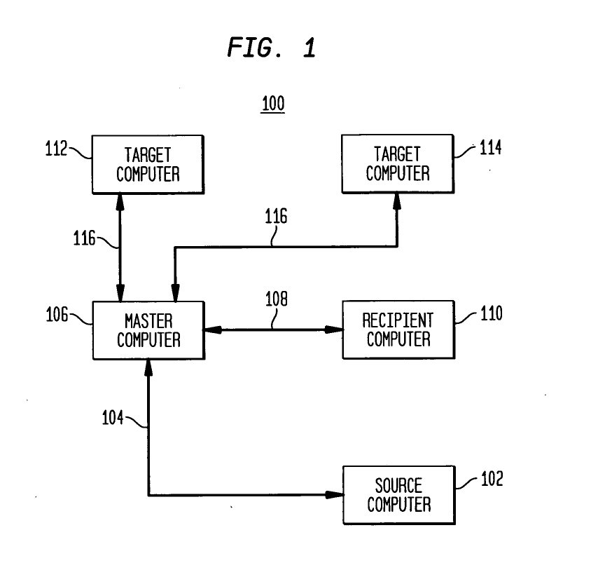

FIG. 1 illustrates a system 100 constructed in accordance with the principles of the present invention for installing software on a target computer system. System 100 may include a source computer 102, a master computer 106, recipient computer 110, and target computers 112 and 114. Generally speaking, system 100 may operate as follows. A particular software package (e.g. Windows XP) may be installed on source computer 102. Source computer 102 is preferably a fast and recent computer (e.g., the fastest and most advanced microprocessor with the most advanced hardware and software), using a high-level HAL (e.g., an Advanced Configuration and Power interface (ACPI) HAL). The software package may be prepared for imaging by running any of several well-known preparation routines such as the Microsoft SysPrep utility to create a disk image. This disk image may then be uploaded to master computer 106 via communications link 104 using known software such as Ghost or Drive Image from Symantec Corporation.

Communications links 104, 108, and 116 may be any suitable wireless or hardwired communications links for transferring electronic information such as a USB link or parallel port, Ethernet link, Token Ring link, Fiber link, a wireless network link (e.g., IEEE 802.XX), or the like.

After the software image is created it may be downloaded from master computer 106 to recipient computer 110 via communications link 108 for installation. In some embodiments, it may be necessary to update the HAL of recipient computer 110 in order to be able to produce the desired subsequent software image for installation in slower computers running earlier or less sophisticated versions of HAL (discussed in more detail below). It should also be noted that source computer 102 and recipient computer 110 may be the same computer; however, for illustrative purposes source computer 102 and recipient computer 110 are discussed as separate machines.

Next, recipient computer 110 may be rebooted for the disk image and HAL change to take effect. At this point, the software package now installed on recipient computer 110 (such as Windows XP) may be re-imaged as described above and transferred to master computer 106. This new image may be transferred to and subsequently installed on various target computers 112 and 114 even if each of these systems includes HAL layers that are less sophisticated or operate more slowly than those found on source computer 102.

Thus, the generalized system depicted in FIG. 1 provides a way in which software may be installed on a target computer system independent of the HAL version resident on the target system. This allows computer operators to more closely control the software configuration of client computers as well as vastly simplify the software installation process.

Additionally, although the generalized system of FIG. 1 includes a master computer 106, it will be understood that this component may be removed if desired and source computer 102 may be partitioned or otherwise configured to function as both master computer 106 and source computer 102 and communicate directly with recipient computer 110 (not shown).

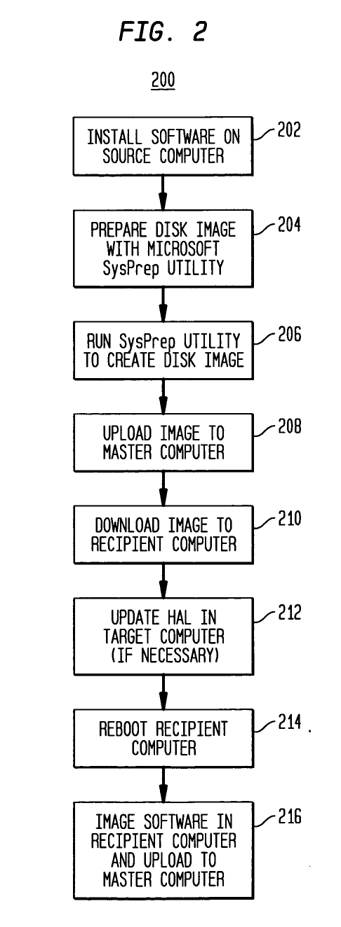

A more detailed description of some of the steps involved in transferring software from one computer to another in accordance with the present invention is illustrated in FIG. 2.

As shown in FIG. 2, the first step (step 202) involves installing a software package, such as Windows XP (with or without associated application programs), on source computer 102, preferably on the fastest and most recent computer technology available, which uses an advanced HAL layer such as an ACPI Uniprocessor HAL and configuring the software as desired.

Next, at step 204, the Microsoft SysPrep or other preparation software is used to prepare an image of the software on source computer 102. In some embodiments this may involve modifying the preparation software prior to imaging in order to account for various kinds of storage media. This may be done, for example, with the Microsoft SysPrep utility by adding the following program statements to the SysPrep.inf file:
[SysPrep]
   BuildMassStorageSection=YES
[SysPrepMassStorage]

Once this has been accomplished (if necessary), the image preparation software (e.g., SysPrep) may be run to create a disk image of the software to be transferred to one or more target computers (112 and 114 shown in FIG. 1). This is accomplished at step 206. At step 208, the disk image created on source computer 102 may be uploaded to master computer 106 via link 104 using known software such as Ghost or Drive Image. At this point, the software image may be downloaded at step 210 to recipient computer 110, which is preferably running the most recent or advanced HAL version such as ACPI Uniprocessor PC HAL.

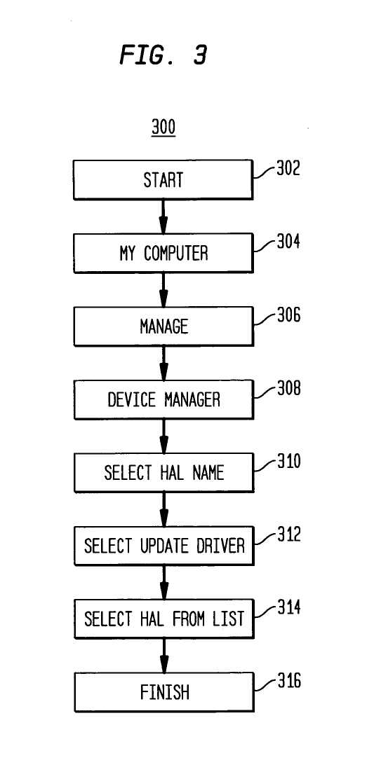

If target computer 112 or 114 is not running acceptable HAL versions, they may be updated at step 212. In some embodiments this may involve updating a dynamic link library file (DLL) on recipient computer 110 so that a subsequent software image will contain the required DLL files. This may include adding, changing, or updating suitable DLLs for the required computer such as Hal.dll (DLL in Standard PC HAL) or Halacpi.dll (DLL in ACPI PC HAL) with Halaacpi.dll (DLL in ACPI Uniprocessor PC) as labeled in Windows XP. One way of performing this update is described in more detail below in connection with the flow chart of FIG. 3.

Next, at step 214, recipient computer 110 is restarted so that the HAL update becomes effective and the transferred software image is fully installed. At step 216, the Microsoft SysPrep utility may be run again with the modification to the SysPrep.inf file disclosed above to create an image of the software package now installed on recipient computer 110. This software image may then be transferred using Ghost or Drive Image back to master computer 106 for storage. Subsequently, this software image may be installed on target systems 112 and 114 that may be running different HAL versions such as ACPI PC, Standard PC, or MPS PC. Thus, in this way, computer software may be imaged from a computer with a more recent HAL version and installed on a computer with an older or different HAL version without experiencing compatibility problems.

FIG. 3 is a flow chart 300 illustrating some of the steps involved in updating the HAL on recipient computer 110 as performed by a computer user with a recent Windows based operating system. First, at step 302, the user selects the “Start” menu normally found on the lower left-hand corner of the computer screen. Next, the user right clicks on “My Computer” (step 304) and selects “Device Manager” (step 306). At this point, the user expands “Computer” and right clicks on HAL name (under Computer) at step 308. At step 310, the user clicks on “Update Driver” and selects the option “Install from a list or specific location (Advanced)” and clicks on “Next”. At step 312, the user selects “Don't search, I will choose the driver to install” and clicks “Next”. At step 314, the user selects the appropriate HAL from the list and clicks on “Next” and then “Finish” at step 316.

Thus, systems and methods for creating a software image for subsequent installation on a target computer system are provided. It will be understood that the foregoing is only illustrative of the principles of the invention, and that various modifications can be made by those skilled in the art without departing from the scope and spirit of the invention.

Persons skilled in the art will appreciate that the present invention can be practiced by other means than the described embodiments, which are presented for purposes of illustration rather than of limitation, and the present invention is limited only by the claims that follow.

1. A method for creating a software image for subsequent installation on a target computer system comprising:
creating an image of software on a source computer;
transferring the software image to a recipient computer and installing software included in the software image on the recipient computer;
updating a hardware abstraction layer on the recipient computer to a required version, if necessary; and
imaging the software installed on the recipient computer with the updated hardware abstraction layer for subsequent installation on a target computer system.

2. The method of claim 1, wherein the creating an image of software on a source computer includes the use of Microsoft SysPrep imaging software.

3. The method of claim 1, wherein transferring the software image to a recipient computer is accomplished via a communications link.

4. The method of claim 3, wherein the communications link is an Ethernet link.

5. The method of claim 3, wherein the communications link is a Token Ring link.

6. The method of claim 3, wherein the communications link is a fiber optic link.

7. The method of claim 1, wherein the updating includes restarting the recipient computer before performing the imaging step.

8. The method of claim 1, wherein the software is an operating system.

9. The method of claim 8, wherein the operating system is Windows XP operating system.

10. A method for installing an imaged operating system on a target computer independent of a hardware abstraction layer present on the target computer, the method comprising:
installing the operating system on a first computer as desired by a user;
creating an image of the installed operating system;
transferring the image of the operating system to a second computer and installing the operating system on the second computer; and
imaging the installed operating system on the second computer with an updated hardware abstraction layer for subsequent installation on a target computer system.

11. The method of claim 10, wherein the creating an image of software on a source computer includes the use of Microsoft SysPrep imaging software.

12. The method of claim 10, wherein transferring the software image to a recipient computer is accomplished via a communications link.

13. The method of claim 12, wherein the communications link is an Ethernet link.

14. The method of claim 12, wherein the communications link is a Token Ring link.

15. The method of claim 12, wherein the communications link is a fiber optic link.

16. The method of claim 10, wherein the updating includes restarting the recipient computer before performing the imaging step.

17. The method of claim 10, wherein the software is an operating system.

18. The method of claim 17, wherein the operating system is Windows XP operating system.

19. A system for creating a software image for subsequent installation on a target computer system comprising:
a source computer;
a first disk imaging means for creating an image of a software application on the source computer;
a first communication link for transferring a software image from the source computer to a recipient computer, wherein software included in the transferred software image is installed on the recipient computer;
a means for updating a hardware abstraction layer on the recipient computer to a required version, if necessary;
a second disk imaging means for imaging the software installed with the updated hardware abstraction layer on the recipient computer; and
a second communication link for transferring a software image from the recipient computer to a target computer system.
